(19) United States
(12) Patent Application Publication
(10) Pub. No.: US 2009/0078268 A1
(43) Pub. Date: Mar. 26, 2009

(54) BUCKLE HAVING A FLEXURAL STRAP ATTACHMENT MEMBER AND RESPIRATOR USING SUCH BUCKLE

(75) Inventors: Daniel J. Stepan, Woodbury, MN (US); Yonas Gebrewold, Woodbury, MN (US); Lance E. Behymer, Woodbury, MN (US); Dwayne D. Daugaard, Hudson, WI (US); Michael K. Domroese, Woodbury, MN (US)

Correspondence Address: 3M INNOVATIVE PROPERTIES COMPANY, PO BOX 33427, ST. PAUL, MN, 55133-3427, US

(73) Assignee: 3 M Innovative Properties Company

(21) Appl. No.: 12/202,498

(22) Filed: Sep. 2, 2008

Related U.S. Application Data
(60) Provisional application No. 60/994,644, filed on Sep. 20, 2007.

(51) Int. Cl. A62B 18/08; A44B 11/06

(52) U.S. Cl. 128/207.11; 24/191

(57) ABSTRACT

Respirator and buckle having a flexural member allowing the buckle to move in three dimensions, potentially improving user comfort, the effectiveness of the respirator, and allowing for more precise adjustments to be made to the fit of the respirator on the user. The flexural member may be a three dimensional living hinge. By lifting on the buckle, the straps that secure the respirator to the user are released and the ability of the buckle to move in three dimensions tends to increase the situations in which the adjustment may occur. Various types of three dimensional living hinges may be utilized, including a cylindrical hinge and a serpentine hinge.

### CROSS-REFERENCE TO RELATED APPLICATION

This application claims the benefit of U.S. Provisional Patent Application No. 60/994,644, filed Sep. 20, 2007.

### FIELD

The present invention relates generally to respirators, buckles, buckle hinges and, more particularly, to respirators and buckles with hinges facilitating strap attachment.

### BACKGROUND

Respirators are commonly worn over the breathing passages of a person for at least one of two common purposes: (1) to prevent impurities or contaminants from entering the wearer's breathing track; and (2) to protect other persons or things from being exposed to pathogens and other contaminants exhaled by the wearer. In the first situation, the respirator is worn in an environment where the air contains particles that are harmful to the wearer, for example, in an auto body shop. In the second situation, the respirator is worn in an environment where there is risk of contamination to other persons or things, for example, in an operating room or clean room.

Some respirators are categorized as being “filtering face-pieces” because the mask body itself functions as the filtering mechanism. Unlike respirators that use rubber or elastomeric mask bodies in conjunction with attachable filter cartridges (see, e.g., U.S. Pat. No. 5,062,421 to Burns et al.) or insert-molded filter elements (see, e.g., U.S. Pat. No. 4,790,306 to Braun), filtering face-piece respirators have the filter media comprise much of the whole mask body so that there is no need for installing or replacing a filter cartridge. As such, filtering face-piece respirators are relatively light in weight and easy to use.

Various embodiments for securing the respirator to the user are known in the art. A known embodiment includes the use of buckles, secured to the respirator, with a strap that is removably secured to each of the buckles and that passes behind the user's head relative to the respirator mask. The strap may be tightened and loosened by operation of the buckle. In various embodiments, the buckle has a two-dimensional living hinge, and by lifting the buckle such that the buckle rotates on the hinge, the strap may be loosened. The term “living hinge” is a term of art for a hinge that is integral, i.e., made at the same time. Instead, the hinge moves about a portion that may be weakened or otherwise made flexible relative to the rest of the hinge. In the case of a two dimensional living hinge, the hinge may move about a flexible portion in only two dimensions, in an action that may be reminiscent of the motion of commonly known door hinges.

### SUMMARY OF THE INVENTION

The buckles used on respirator masks that are known in the art, however, suffer from the common issue of being comparatively inflexible due to the use of the two-dimensional living hinge. Because the buckle is configured to flex up and down, but not side to side, torsionally or rotationally, the hinge may be poorly configured to adapt the fit of the respirator to the physical characteristics of the user wearing the respirator. Poor fit may lead to reduced user comfort and increased difficulty in adjusting the positioning of the respirator on the user's face. For instance, while it is commonly the case that the adjustable straps of the respirator may be adjustable while the respirator is not being worn, the straps of respirators with two dimensional living hinges commonly may be difficult to be adjusted while the respirator is being worn or, especially, while the respirator is being doffed by the user. Additionally, if the most comfortable positioning of the strap for the user is close to one portion of the user's head, but the buckles are configured on the respirator mask such that the strap is directed close to another portion of the head, it may be difficult for the user to maintain the straps at a particular location on the head. This may increase user discomfort, as well as decrease the effectiveness of the respirator itself, if the poorly positioned strap impacts the fit of the mask over the user's mouth and nose.

An embodiment improves the fit, comfort and adjustability of the respirator by utilizing buckles with flexural members that allow the buckles to flex and move rotationally and tortionally, in addition to the up and down motion of buckles that utilize a two dimensional living hinge. In an embodiment, the flexural member may be a three dimensional living hinge. Because the buckles may be enabled to flex in three dimensions, as well as rotate, the buckles may be better capable of adopting an orientation with respect to the user's head to increase user comfort and effectiveness of the respirator mask, as well as potentially allowing for adjustment of the straps during use.

In various embodiments, the use of different kinds of three dimensional living hinges is envisioned. In an embodiment, a cylindrical hinge may be used, created by significantly narrowing the width of the material comprising the hinge in one section, such that the narrowed section becomes flexible relative to the rest of the hinge. In an alternative embodiment, a serpentine hinge may be used, by creating a serpentine or “S” shape in one section of the material comprising the hinge.

In an embodiment, the present invention provides a buckle. The buckle has a strap attachment portion having a slot and a cinch bar, an anchoring portion and a flexural member. The flexural member is operatively coupled between the strap attachment portion and the anchoring portion and allows for rotational movement and tortional movement between the strap attachment portion and the anchoring portion.

In an embodiment, the flexural member is a three dimensional living hinge.

In an embodiment, the slot and the cinch bar are configured to secure a strap passed through the slot.

In an embodiment, the strap attachment portion has a lifted position and a neutral position, and wherein the slot and the cinch bar are configured to release the strap upon the attachment portion being lifted to the lifted position.

In an embodiment, the anchoring portion has an anchoring width, the three dimensional living hinge has a hinge width and wherein the hinge width is less than the anchoring width.

In an embodiment, the anchoring portion and the strap attachment portion have an anchoring width and wherein the three dimensional living hinge has a hinge width, wherein the hinge width is less than the anchoring width.

In an embodiment, the three dimensional living hinge is a serpentine hinge.

In an embodiment, a ratio of the hinge width over the anchoring width is not greater than twenty percent.

In an embodiment, the present invention provides respirator having a mask, a buckle and a strap having a first end and a second end, the first end being securable to the strap attachment portion and the second end being secured to the opposite side of the mask, perhaps through another buckle. The buckle has a strap attachment portion having a slot and a cinch bar, an anchoring portion, the anchoring portion being operatively coupled to the mask, and a flexural member. The flexural member is operatively coupled between the strap attachment portion and the anchoring portion, the flexural member allowing for rotational movement and tortional movement between the strap attachment portion and the anchoring portion.

In an embodiment, the respirator further has a plurality of the buckles, the anchoring portions of the plurality of the buckles being operatively coupled to the mask, and at least one of the straps. Further, the first end of the strap is secured to the strap attachment of an individual one of the plurality of buckles, and wherein the second end of the strap is secured to the strap attachment of a different individual one of the plurality of buckles.

### Glossary

The terms set forth below will have the meanings as defined:

“bisect(s)” means to divide into two generally equal parts;

“centerline” means a line that bisects the mask vertically when viewed from the front (FIG. 1);

“centrally spaced” means separated from one another along a line or plane that bisects the mask body vertically when viewed from the front;

“comprises (or comprising)” means its definition as is standard in patent terminology, being an open-ended term that is generally synonymous with “includes”, “having”, or “containing”. Although “comprises”, “includes”, “having”, and “containing” and variations thereof are commonly-used, open-ended terms, this invention also may be suitably described using narrower terms such as “consists essentially of”, which is semi open-ended term in that it excludes only those things or elements that would have a deleterious effect on the performance of the inventive respirator in serving its intended function;

“contaminants” means particles (including dusts, mists, and fumes) and/or other substances that generally may not be considered to be particles (e.g., organic vapors, et cetera) but which may be suspended in air, including air in an exhale flow stream;

“crosswise dimension” is the dimension that extends laterally across the respirator from side-to-side when the respirator is viewed from the front;

“exterior gas space” means the ambient atmospheric gas space into which exhaled gas enters after passing through and beyond the mask body and/or exhalation valve;

“filtering face-piece” means that the mask body itself is designed to filter air that passes through it; there are no separately identifiable filter cartridges or inserted-molded filter elements attached to or molded into the mask body to achieve this purpose;

“filter” or “filtration layer” means one or more layers of air-permeable material, which layer(s) is adapted for the primary purpose of removing contaminants (such as particles) from an air stream that passes through it;

“filtering structure” means a construction that is designed primarily for filtering air;

“first side” means an area of the mask body that is laterally distanced from a plane that bisects the respirator vertically and that would reside in the region of a wearer's cheek and/or jaw when the respirator is being donned;

“flexural member” means a member that is capable of being substantially flexed or bent;

“harness” means a structure or combination of parts that assists in supporting the mask body on a wearer's face;

“hinder movement” means impede, restrict, or deprive of movement when exposed to forces that exist under normal use conditions;

“integral” means made at the same time and not two separate pieces that are joined together;

“interior gas space” means the space between a mask body and a person's face;

“living hinge” means a mechanism that allows members that extend therefrom to generally pivot thereabout in a rotational-type manner with such ease that little or no damage is caused to the members or to the hinge joint;

“longitudinally-movable” and “move longitudinally” means capable of being moved in the longitudinal direction in response to mere finger pressure;

“mask body” means an air-permeable structure that is designed to fit over the nose and mouth of a person and that helps define an interior gas space separated from an exterior gas space;

“member”, in relation to the support structure, means an individually and readily identifiable solid part that is sized to contribute significantly to the overall construction and configuration of the support structure;

“perimeter” means the outer edge of the mask body, which outer edge would be disposed generally proximate to a wearer's face when the respirator is being donned by a person;

“pleat” means a portion that is designed to be folded back upon itself;

“pleated” means being folded back upon itself;

“plastic” means a material that mainly includes one or more polymers and may contain other ingredients as well;

“plurality” means two or more;

“respirator” means an air filtration device that is worn by a person to provide the wearer with clean air to breathe;

“rotational movement” means the turning of the moving object around an axis;

“second side” means an area of the mask body that is distanced from a plane line that bisects the mask vertically (the second side being opposite the first side) and that would reside in the region of a wearer's cheek and/or jaw when the respirator is being donned;

“support structure” means a construction that is designed to have sufficient structural integrity to retain its desired shape, and to help retain the intended shape of the filtering structure that is supported by it, under normal handling;

“spaced” means physically separated or having measurable distance therebetween;

“torsional movement” means the twisting of the moving member;

“transversely extending” means extending generally in the crosswise dimension.

### BRIEF DESCRIPTION OF THE DRAWINGS

FIG. 1 shows an example of a respirator with buckles with flexural members positioned over a user's mouth and nose;

FIG. 2 shows a side view of the respirator of FIG. 1;

FIG. 3 shows a view of filtering structure of the respirator of FIG. 1;

FIG. 4 shows a front-view of an example of a respirator with buckles having three dimensional living hinges;

FIG. 5 shows a view of an embodiment of the buckle of FIG. 4, the buckle having a cylindrical living hinge;

FIG. 6 shows a view of an alternative embodiment of the buckle of FIG. 4, the buckle having a serpentine living hinge;

FIG. 7 shows a view of a buckle in a lifted position;

FIG. 8 shows a view of a buckle in a turned position; and

FIG. 9 shows a view of a buckle in a torsionally rotated position.

### DETAILED DESCRIPTION

In order to increase the usefulness and functionality of a buckle used for securing a strap, it is desirable to provide a buckle that allows for flexing and movement that exceeds two dimensional movement. A buckle that exceeds two dimensional movement may improve the ability of the buckle to conform to an object to which it is being secured, and may allow easier adjustments to be made to the strap. Particularly in situations where the buckle is being utilized to secure an object to a person, the ability of the buckle to move in three dimensions may improve the comfort and fit of the object being secured, and improve the ability of the user to adjust the buckle.

In an embodiment, a buckle has been developed with a flexural member that allows for rotational and torsional movement of the buckle. In an embodiment, the flexural member may be three dimensional living hinges. The greater range of movement that may be realized by the ability to move in three dimensions may improve the comfort and fit of objects intended to be secured to the body of a person. Such objects may include personal entertainment equipment, such as personal music players, or a belt for use on pants. Other such objects may include medical or safety equipment, such as a Holter monitor or a respirator mask.

In order to increase the comfort and effectiveness of a respirator mask, it is desirable to provide a strap and buckle structure that easily allows for easy adjustments of the length and tension on the strap and more precise fitting on the face of the user. Respirator masks are commonly manufactured with buckles having hinges that allow for flexibility in only two dimensions. Thus, the range over which the respirator mask may be positioned or adjusted is limited by the ability to flex the hinges in only those two directions. Commonly, this results in respirators that can be adjusted in relatively limited ways.

In an embodiment, a respirator has been developed with buckles that utilize living hinges with flexibility in three dimensions, allowing for movement laterally, vertically, rotationally and tortionally. The greater range of movement in the hinges may provide a better fit due to a greater ability to conform to the contours of the user's head, and an increased ability to adjust the straps that are secured to the buckles and which are used to secure the respirator to the user's head.

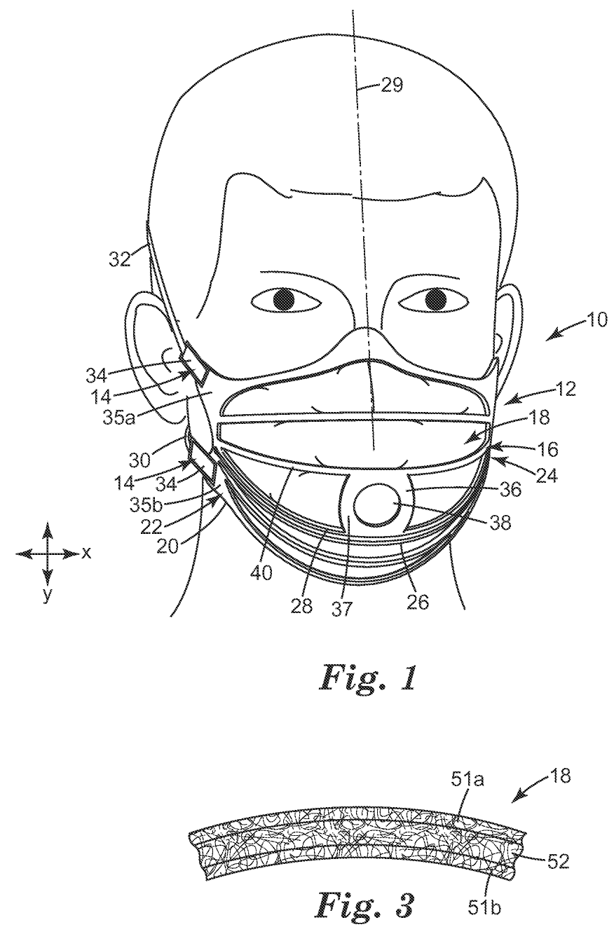

FIG. 1 shows a respirator 10 that is being worn over the nose and mouth of a person. The respirator 10 includes a mask body 12 and a harness 14. The mask body 12 has a support structure 16 and a filtering structure 18. The support structure 16 includes a perimeter 20, a first side 22, and an opposing second side 24. The perimeter 20 of the support structure 16 may, but not necessarily, contact the wearer's face when the respirator 10 is being donned. The perimeter 20 may comprise a member, or combination of members, that extend 360° continuously about, and adjacent to, the periphery of the mask body 12. Typically, the wearer's face will contact only the inner surface or periphery of the filtering structure 18 (or an additional face seal material) so that a comfortable fit is achieved. Thus, the peripheral edge of the filtering structure 18 may extend slightly beyond the perimeter 20 of the support structure 16.

The support structure 16 also includes a longitudinally-movable, transversely-extending member 26. This longitudinally-movable, transversely-extending member 26 extends from a first side 22 of the mask body 12 to a second side 24 without being joined together between sides 22 and 24 by any longitudinally-extending member(s) that could hinder movement of the transversely-extending members 26 in a longitudinal direction. That is, there is no structural member that joins member 26 to member 28 so as to restrict member 26 from moving away from member 28 when the wearer expands their jaw or opens their mouth. The longitudinal movement that is beneficially achieved according to the illustrated embodiment is particularly pronounced along the center line 29. Transversely-extending members 26, 28 converge towards each other moving from centerline 29 to each side 22, 24 of the support structure 16. When viewing the respirator as projected onto a plane from the front, the transverse dimension extends across the respirator in the general “x” dimension, and the longitudinal dimension that extends between the bottom and top of the respirator 10 in the general “y” dimension. When viewed through such a planar projection, the transversely-extending member 26 can move towards and away from member 28 in the general “y” direction. In so doing, the member 26 moves towards and away from member 28 a greater distance along the center line 29 than at the first and second sides 22 and 24 where the transversely-extending members merge together.

The harness 14 includes first and second straps 30 and 32 that may be adjusted in length by one or more buckles 34. The harness 14 may be secured to the mask body 12 at the first and second sides 22, 24 at harness-securement flange members 35a, 35b. The buckles 34 may be secured to the mask body 12 at flange members 35a, 35b by a variety of methods, including stapling, adhesive bonding, welding, and the like. The buckles also may be integrally molded into the support structure 16. The mask body 12 also includes an optional frame 36 that has an opening 38 located therein. The frame 36 provides a location or foundation for securing an exhalation valve (not shown) to the mask body 12. Although the transversely-extending members 28 and 40 are joined together by longitudinally extending members 37 on the frame 36, the mask body 12 nonetheless may be expanded by relatively free movement between members 26 and 28 and other members that are not so joined relative to one another. Thus, although the invention contemplates having one or more members (2, 3, 4, 5, etc.) that exhibit the capacity to move longitudinally toward or away from each other, not all transversely extending members need to demonstrate such behavior with respect to each adjacent member to accomplish objectives in accordance with the present invention.

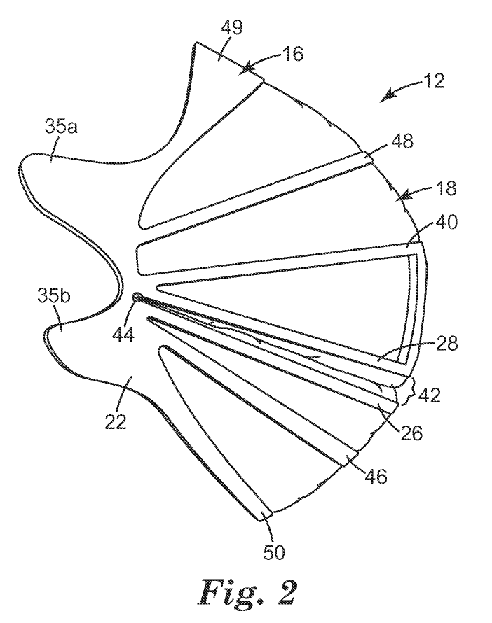

FIG. 2 illustrates a side view of the mask body 12 where transversely-extending members 26 and 28 are positioned adjacent to one another such that the filtering structure 18 becomes pleated therebetween in pleatable region 42. The support structure 16 of mask body 12 may further include a living hinge 44 located in the region where movable transversely extending member 26 meets member 28. The living hinge 44 is beneficial in that it allows transversely-extending members 26 and 28 to more easily move towards one another or to move apart from one another. In an embodiment, living hinge 44 has a cul-de-sac shape.

In a further embodiment, living hinge 44 also is disposed between upper and lower harness attachment flanges 35a and 35b in the “y” dimension when the mask 12 is oriented in an upright configuration as shown in FIG. 2. In an embodiment, there are one, two, three, or more living hinges disposed between the point where the harness 14 (FIG. 1) exerts its force on the mask body (in this instance at flanges 35a and 35b). As shown in FIG. 2, there are other transversely-extending members 46, 48, 49, and 50 that do not have longitudinally-extending members located therebetween away from each side 22 or 24. Thus, while transversely-extending members 46 and 48, for example, may be able to move in a longitudinal dimension to allow the mask body 12 to expand or contract, these members may not be as freely movable as member 26 because the former lacks a cul-de-sac-shaped living hinge where they come together at the first and second side portions 22 and 24. Therefore, although only one such living hinge 44 is illustrated at each end of the transversely-extending members 26, 28, 46, 48, 49 and 50, the present invention does indeed contemplate using such additional living hinges between additional transversely-extending members. The living hinges may be used where the transversely-extending members meet. There should not, however, be any longitudinally-extending members located between members that are intended to move longitudinally toward or away from one another. As shown, each of the transversely-extending members 26, 28, 40, 46, 48, 49, and 50 converge towards each other in the direction moving away from the centerline 29 toward each of the sides 22, 24. At each side, the transversely-extending members within the perimeter (i.e. members 26, 28, 40, 46, and 48) may converge towards each other such that all the members are within 35 mm or less from each other when viewed from the side; whereas, the same members may be centrally spaced a total of about 50 to 100 mm at the centerline 29 (FIG. 1).

FIG. 3 shows a cross-section of the filtering structure 18. As illustrated, the filtering structure 18 may include one or more cover webs 51a and 51b and a filtration layer 52. The cover webs 51a and 51b may be located on opposing sides of the filtration layer 52 to capture any fibers that could come loose therefrom. Typically, the cover webs 51a and 51b are made from a selection of fibers that provide a comfortable feel, particularly on the side of the filtering structure 18 that makes contact with the wearer's face. The construction of various filter layers and cover webs that may be used in conjunction with the support structure of the present invention are described below in more detail.

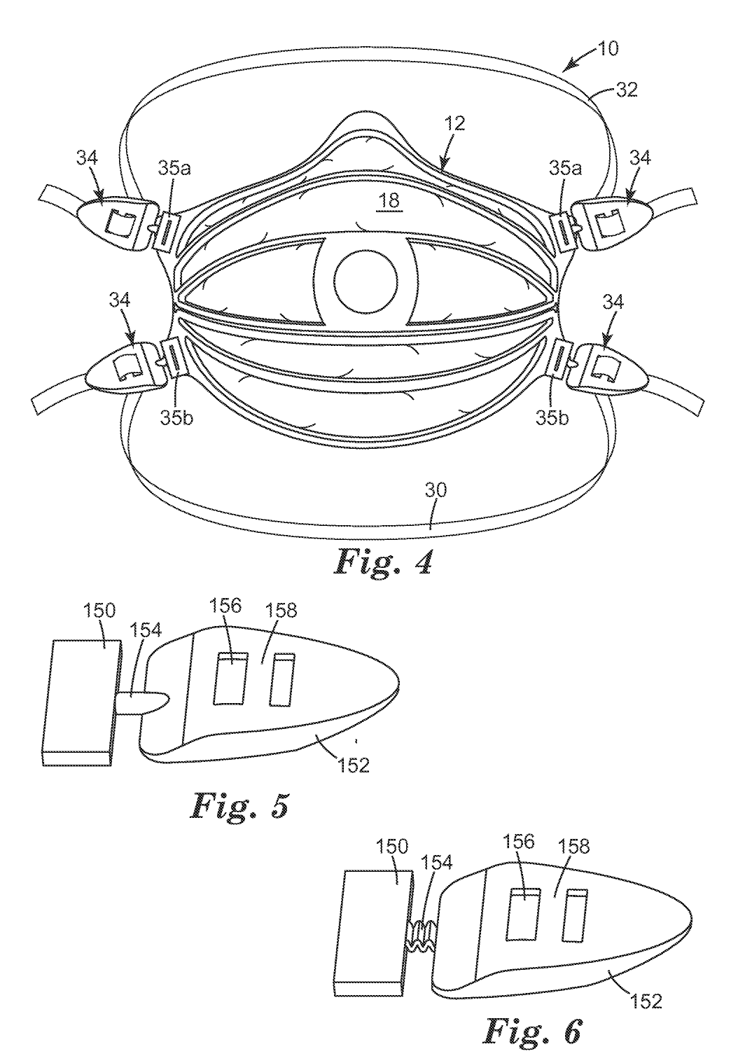

FIG. 4 shows an embodiment of respirator 10 of FIG. 1 which has been adapted with buckles 34. Buckles 34 comprise anchoring portion 150, strap attachment portion 152 and a flexural member such as hinge 154 as shown in FIG. 5 and FIG. 6. Anchoring portion 150 is operatively coupled to flange members 35a, 35b of mask body 12. In alternative embodiments, flange members 35a, 35b may not be a component of mask body 12 and anchoring portion 150 may be operatively coupled to mask body 12 generally. In various embodiments, anchoring portion 150 is operatively coupled to flange members 35a, 35b with a staple, adhesive or any suitable means of securing anchoring portion 150 to flange members 35a, 35b known in the art.

In an embodiment, a first end of strap 30, 32 is secured to strap attachment portion 152 of a first buckle 34, while a second end of strap 30, 32 is secured to strap attachment portion 152 of a second buckle 34 on the opposite side of mask body 12 from the first buckle 34. In various embodiments, strap 30, 32 may be removably or adjustably secured to strap attachment portion 152. In alternative embodiments, strap 30, 32 may be fixedly attached to strap attachment portion 152. In various embodiments, combinations of strap 30, 32 being adjustably or removably secured to strap attachment portion 152 on the same respirator 10 is envisioned. In such an embodiment, strap 30, 32 may be adjusted without strap 30, 32 separating from respirator 10 altogether.

FIG. 5 shows a close view an embodiment of buckle 34. In an embodiment, buckle 34 is made from a single piece of molded plastic. In an alternative embodiment, buckle 34 is made from more than one piece of molded plastic that have been fixed securely together. Hinge 154 operatively couples anchoring portion 150 and strap attachment portion 152. In the illustrated embodiment, hinge 154 is a cylinder-type three dimensional living hinge, defined by comprising a relatively narrowed segment of buckle 34 compared with the width of buckle 34 generally. In an embodiment, the width of buckle 34 is approximately 19.5 millimeters and the width of hinge 154 is approximately 3.2 millimeters. In an embodiment, the hinge width of hinge 154 is not more than 20% of the anchoring width of anchoring portion 150. In various embodiments, hinge 154 is not more than 18% of the width of anchoring portion 150, and is not more than 15% of the width of anchoring portion 150. In an alternative embodiment, both the anchoring portion and the strap attachment portion have the same anchoring width. The narrower the width of hinge 154, the greater the flexibility buckle 34 may tend to have, but narrowing the width of hinge 154 may come at the cost of making buckle 34 flimsy and prone to breaking. How narrow the width of hinge 154 should be may depend on the material used in buckle 34, though in many embodiments the width of hinge 154 may be not more than 20% of the width of anchoring portion 150.

In an embodiment, straps 30, 32 may be secured to strap attachment portion 152 by looping straps 30, 32 around cinch bar 58. A first end of strap 30, 32 is inserted into slot 156 which is closest to living hinge 154. Then strap 30, 32 is looped around cinch bar 158 at the top surface of buckle 34 and then inserted back into slot 159 (furthest from living hinge 154). Once the loop is created, the two layers of strap 30, 32 is pinched by the bottom of the body of strap attachment portion 152 holding strap 30, 32 under tension.

When strap 30, 32 has been arranged in such a manner, and when buckle 34 is in a neutral position, and little to no upward pressure relative to anchoring portion 150 and flange members 35a, 35b is being applied to strap attachment portion 152, strap 30, 32 may be secured to buckle 34 by friction applied from cinch bar 158, among other sources. In order to release strap 30, 32 from buckle 34, upward pressure may be applied to strap attachment portion 152, lifting strap attachment portion 152 relative to anchoring portion 150. When strap attachment portion has lifted to or beyond a particular lifted position, the friction exerted by cinch bar 158 may be reduced to the point where strap 30, 32 may begin to slide relative to buckle 34. A user may re-exert friction by releasing strap attachment portion 152 such that strap attachment portion lowers to a position below the lifted position threshold, thereby adjusting the length of strap 30, 32 between buckles 34, which may adjust the fit of respirator 10. Alternatively, a user may maintain strap attachment portion 152 at or above the lifted position until strap 30, 32 has entirely separated from buckle 34.

FIG. 6 illustrates an alternative embodiment of buckle 14. The cylindrical-type living hinge 154 of FIG. 5 maybe substituted for a serpentine-type living hinge 160. By virtue of its relatively greater width, serpentine hinge 160 may be more robust and less prone to breakage than cylindrical hinge 154, but may be somewhat less flexible. Serpentine hinge 160 may tend to be flexible in an additional direction compared with cylindrical hinge 154, as serpentine hinge 160 may be capable of extending laterally by virtue of its serpentine-shape. Additional types of three dimensional living hinges are also envisioned that may be optimized for specific situations and particular needs.

FIGS. 7-9 show the embodiment illustrated in FIG. 5 flexed in various aspects to demonstrate a range of motion of buckle 34.

FIG. 7 shows buckle 34 in a lifted position, in an embodiment from pressure being applied to strap attachment portion 152. In various embodiments, pressure down on strap attachment portion 152 may flex hinge 154 to a down-position. In a configuration where strap 30, 32 is secured to buckle 34, but lifting buckle 34 to the lifted position, the friction exerted by cinch bar 158 specifically, and by buckle 34 generally, on strap 30, 32 may decrease, as the lifting may reduce the percentage of cinch bar 158 in contact with strap 30, 32. As the friction on strap 30, 32 decreases, strap 30, 32 may become less secured to buckle 34. In embodiments where strap 30, 32 is made of an elastic material, when the force from the tension on strap 30, 32 from being extended exceeds the friction exerted by cinch bar 158 and buckle generally on strap 30, 32, strap 30, 32 may begin to move relative to buckle 34.

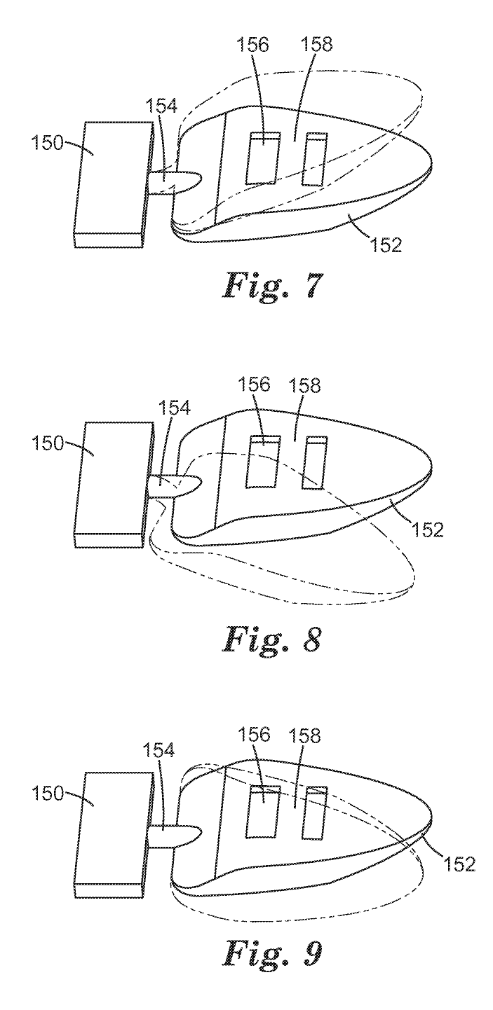

FIG. 8 shows buckle in a turned position. In an embodiment, pressure applied to the right of strap attachment portion 152 may cause strap attachment portion to flex to the left. A similar, opposite result may be expected from pressure being applied to strap attachment portion 152 from the opposite direction. As buckle 34 turns, the position of strap 30, 32 relative to the head of the user may change. Likewise, the ability of a user to turn buckle 34 may improve the ability of the user to adjust strap 30, 32, as the ability to turn buckle 34 may impact the amount of friction exerted by cinch bar 158 and buckle generally on strap 30, 32, which may allow for adjustment of strap 30, 32 in circumstances beyond what may be possible without the ability of buckle 34 to turn.

FIG. 9 shows buckle 34 in a rotated position having been rotationally or torsionally moved. The rotated position may be arrived at by upward pressure on one side of strap attachment portion 152 and by downward pressure on the other side of strap attachment portion 152. As buckle 34 rotates, the position of strap 30, 32 relative to the head of the user may change. Where strap 30, 32 is under tension, this may allow strap 30, 32 to assume a comparatively more natural or comfortable position on the head of the user than might be the case if buckle 30, 32 could not rotate. Likewise, the ability of a user to rotate buckle 34 may improve the ability of the user to adjust strap 30, 32, as the ability to rotate buckle 34 may impact the amount of friction exerted by cinch bar 158 and buckle generally on strap 30, 32, which may allow for adjustment of strap 30, 32 in circumstances beyond what may be possible without the ability of buckle 34 to rotate.

Thus, embodiments of the controller for a buckle and a respirator using such a buckle, having a flexural member are disclosed. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. A buckle, comprising:
a strap attachment portion having a slot and a cinch bar;
an anchoring portion; and
a flexural member operatively coupled between said strap attachment portion and said anchoring portion, said flexural member allowing for rotational movement and tortional movement between said strap attachment portion and said anchoring portion.

2. The buckle as in claim 1 wherein said flexural member is a three dimensional living hinge.

3. The buckle as in claim 2 wherein said anchoring portion has an anchoring width, said three dimensional living hinge has a hinge width and wherein said hinge width is less than said anchoring width.

4. The buckle as in claim 2 wherein said anchoring portion and said strap attachment portion have an anchoring width and wherein said three dimensional living hinge has a hinge width, wherein said hinge width is less than said anchoring width.

5. The buckle as in claim 2 wherein said three dimensional living hinge is a serpentine hinge.

6. The buckle as in claim 1 wherein said slot and said cinch bar are configured to secure a strap passed through said slot.

7. The buckle as in claim 6 wherein said strap attachment portion has a lifted position and a neutral position, and wherein said slot and said cinch bar are configured to release said strap upon said strap attachment portion being lifted to said lifted position.

8. The buckle as in claim 7 wherein a ratio of said hinge width over said anchoring width is not greater than twenty percent.

9. A respirator, comprising
a mask;
a buckle, comprising:
a strap attachment portion having a slot and a cinch bar;
an anchoring portion, said anchoring portion being operatively coupled to said mask; and
a flexural member operatively coupled between said strap attachment portion and said anchoring portion, said flexural member allowing for rotational movement and tortional movement between said strap attachment portion and said anchoring portion; and
a strap having a first end and a second end, said first end being securable to said strap attachment portion and said second end being secured, at least indirectly, to said mask.

10. The respirator as in claim 9 wherein said respirator further comprises:
a plurality of said buckles, said anchoring portions of said plurality of said buckles being operatively coupled to said mask, and at least one of said straps;
wherein said first end is secured to said strap attachment of an individual one of said plurality of buckles, and wherein said second end is secured to said strap attachment of a different individual one of said plurality of buckles.

11. The respirator as in claim 9 wherein said flexural member is a three dimensional living hinge.

12. The respirator as in claim 11 wherein said anchoring portion has an anchoring width, said three dimensional living hinge has a hinge width, wherein said hinge width is less than said anchoring width.

13. The respirator as in claim 12 wherein said three dimensional living hinge is a serpentine hinge.

14. The respirator as in claim 12 wherein a ratio of said hinge width over said anchoring width is not greater than twenty percent.

15. The respirator as in claim 11 wherein said anchoring portion and said strap attachment portion have an anchoring width and wherein said three dimensional living hinge has a hinge width, wherein said hinge width is less than said anchoring width.

16. The respirator as in claim 9 wherein said slot and said cinch bar are configured to secure said strap passed through said slot.

17. The respirator as in claim 16 wherein said strap attachment portion has a lifted position and a neutral position, and wherein said slot and said cinch bar are configured to release said strap upon said strap attachment portion being lifted to said lifted position.
